(19) United States
(12) Patent Application Publication
(10) Pub. No.: US 2004/0064704 A1
(43) Pub. Date: Apr. 1, 2004

(54) Secure information display and access rights control

(76) Inventor: Monis Rahman, Mountain View, CA (US)

Correspondence Address: Monis Rahman, 210 Flynn Avenue, Mountain View, CA, 94043, US

(21) Appl. No.: 10/256,506

(22) Filed: Sep. 27, 2002

(51) Int. Cl. H04L 9/00

(52) U.S. Cl. 713/182; 345/741; 713/200

(57) ABSTRACT

Methods, apparatuses and computer program products for secure information display and access rights control. In one embodiment, a method involves uploading a first image from a first user and enabling the first user to set an access attribute that indicates a limited ability for a second user to view the first image. The first image may selectively be provided to the second user in a secure form in accordance with the access attribute.

### BACKGROUND

1. Field

The present disclosure pertains to the field of information storage, processing and distribution. More particularly, the present disclosure pertains to secure information display for controlled or controllable display or distribution of information such as images.

2. Description of Related Art

The Internet and connected networks in general provide great opportunity to share information. In many cases, the ability to readily share information is regarded as positive and a catalyst for favorable communications and interactions. In other cases, however, the ease with which information can be duplicated and transmitted is troubling. For information that one wishes to keep private or to share only in a limited fashion, fear of unchecked copying and distribution may prevent or discourage information holders from digitizing and/or transmitting that information.

For example, copyrighted works such as music or movies may be copied and/or distributed in various forms. In attempts to quash piracy, costly litigation has been used in attempts to eliminate sites that traffic unprotected digital content. Digital Rights Management (DRM) techniques have been proposed to control the usage and distribution of such copyrighted materials. Such techniques typically require specialized locally installed software, hardware, or customized devices that enforce the appropriate restrictions on the provided content. Additionally, many DRM techniques are geared toward the sale and transfer of an item, such as a song, to a particular user.

Document protection has been proposed and is available in various forms. For example, Adobe Corporation of San Jose, Calif. provides Acrobat software and Acrobat Reader software which allows varying degrees of document protection. When a user creates a document, attributes such as printing may be disabled. However, the document requires Adobe software to be installed to view the document and for any of these access restrictions to take effect. Moreover, such documents are readily transferred and distributed.

Image sharing is presently available through several current Internet sites. For example the Ofoto web site (Ofoto.com is maintained by Ofoto, Inc. of Emeryville, Calif.) allows users to post pictures and then invite other users to view their photos. Yahoo! Inc., of Sunnyvale, Calif., provides an Internet briefcase service in which photos may be posted, and permission to either view or not view may be set for a particular user or group. Both of these sites display images in a fashion that allows them to be downloaded and appropriated because the image itself in displayable form is sent to the viewer's web browser. For example, a user may be able to right-click on an image shown in the browser and save that image to their local machine for unrestricted future copying, distribution, etc. Moreover, these sites generally encourage image sharing and distribution and may allow a user to view images without authenticating the user's identity or tracking or accounting for viewing activity.

Thus, while various techniques control content distribution in certain applications, they often impose significant procedures and/or hardware or software requirements on those who wish to securely share information or those who wish to view such information. Other current sharing techniques may impose too few restrictions on the usage of the information that is shared. New techniques to facilitate information sharing and/or revenue-generating business models associated with such new secure sharing techniques may advantageously foster even further information sharing.

### BRIEF DESCRIPTION OF THE FIGURES

The present invention is illustrated by way of example and not limitation in the Figures of the accompanying drawings.

FIG. 1 illustrates one embodiment of an information sharing system utilizing disclosed techniques.

FIG. 2 illustrates one embodiment of a process to share information according to presently disclosed techniques.

FIG. 3a illustrates one embodiment of a process to selectively provide information to a user according to presently disclosed techniques.

FIG. 3b illustrates another embodiment of a process to selectively provide information to a user according to presently disclosed techniques.

FIG. 4 illustrates various access attribute setting options that may be used in one or more embodiments.

FIG. 5 illustrates various access attribute checking options that may be used in one or more embodiments.

FIG. 6 illustrates various revenue models that may be used in one or more embodiments of presently disclosed information sharing techniques.

FIG. 7 illustrates an information sharing system and various implementation options that may be used in some embodiments.

FIG. 8 illustrates one embodiment that provides added security for a database of information that is to be shared on a restricted basis.

FIG. 9 illustrates one embodiment in which a match-making Internet site uses a secure picture display of users.

FIG. 10 illustrates one embodiment of a secure picture site allowing image sharing and notification.

### DETAILED DESCRIPTION

The following description provides techniques for secure information display and access rights control. In the following description, numerous specific details are set forth in order to provide a more thorough understanding of the present invention. It will be appreciated, however, by one skilled in the art, that the invention may be practiced without such specific details.

The present disclosure describes techniques to share information, yet to maintain some degree of control over that information. While no technique to safeguard information is perfect and impervious to information misappropriation, providing reasonable measures of security may be sufficient to entice a large number of users to post information they would not otherwise post. The present disclosure describes techniques that provide some safeguards to prevent the unchecked distribution of information. These techniques may be used, for example, to share personal images. In certain religions and/or cultures, the threat of broad dissemination of personal images may be offensive or at least may give great pause to those who would otherwise consider posting images of themselves on the Internet. Safeguards may overcome these fears for some and allow image sharing and its associated benefits. In one embodiment, a user uploads an image to a mutually accessible storage location. An access attribute is set to provide another user a limited ability to view the image. If the proper conditions are met for viewing, the other user may be provided the image in some cases in a secure form.

The secure form in which the image is provided may vary. As previously mentioned, absolute security remains evasive, and reasonable security is all that is necessary in many applications. Thus, the secure form of the image may be an encoded or an encrypted form. The secure form may involve some type of scrambling or the like to prevent the second user from obtaining the information (e.g., the image) and then being able to freely manipulate and/or transfer the information. Such a system may advantageously facilitate the exchange of information, and particularly in the case of personal images, may facilitate meeting, socializing, and/or courtship.

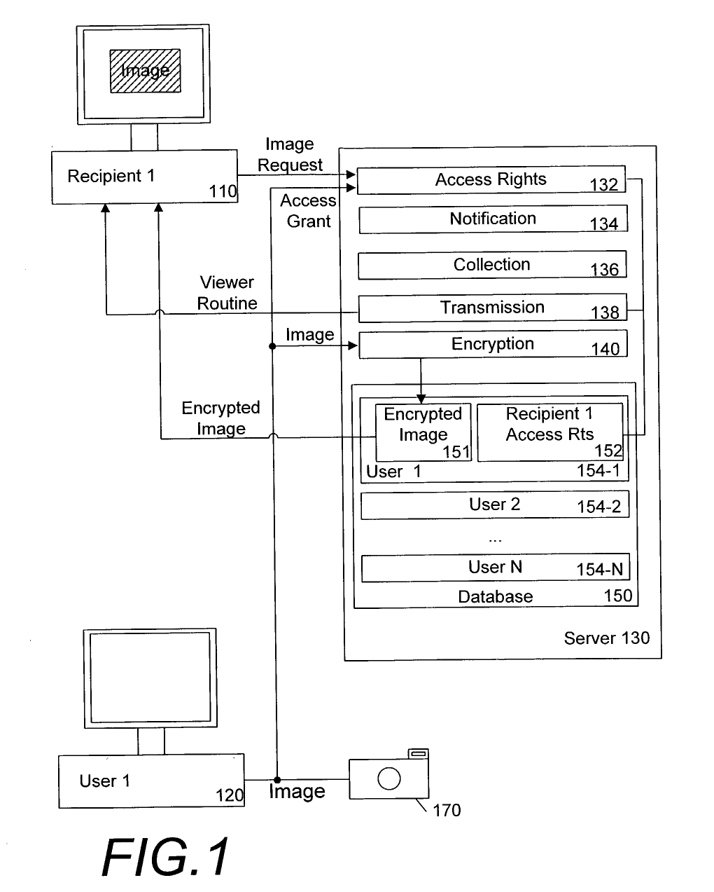

FIG. 1 illustrates one embodiment of a sharing system that may be used to share images or other information elements. In this embodiment, a first user, User 1, and a second user, Recipient 1, operate respectively computers 110 and 120. The computers 110 and 120 are in communication with a server 130. The computers 110 and 120 may be any type of computing device with display and communication or networking capabilities. For example, a desktop or laptop computer, a personal digital assistant, a phone, or a camera (e.g., camera 170), or any other device having very basic computing, display and communications abilities may be used in conjunction with presently disclosed techniques. Information sharing is by no means limited to any specific type of computing device. The computers 110, 120, and 130 may all be connected via a network such as the Internet or may be connected by any other known or otherwise available communication medium. The server 130 may be any system, set of systems (distributed or co-located) that can store and retrieve information elements based on access attributes associated therewith in response to communications from users.

As illustrated in FIG. 1, the server 130 includes various modules and a database 150 to allow sharing of information elements. An access rights module 132, a notification module 134, a collection module 136, a transmission module 138 and an encryption module 140 may all be used to store information in the database 150 and to then transmit such stored information to other users (i.e., recipients) under controlled access conditions and/or in a relatively secure fashion.

For example, when User 1 obtains or identifies an information element that User 1 would like to share, perhaps an image from the camera 170, presently disclosed techniques may be used to facilitate such sharing. Notably, various types of information elements may be shared via disclosed techniques. For example, text, books, architectural plans, schematics, circuits, drawings, artwork, pictures, photo albums, and the like may all also be shared via disclosed techniques. Any of these types of information items or information elements may be encrypted and/or stored as an image for security. As one example, however, User 1 may wish to share an image of himself or herself for the purposes of personal interaction, dating, courtship, or the like.

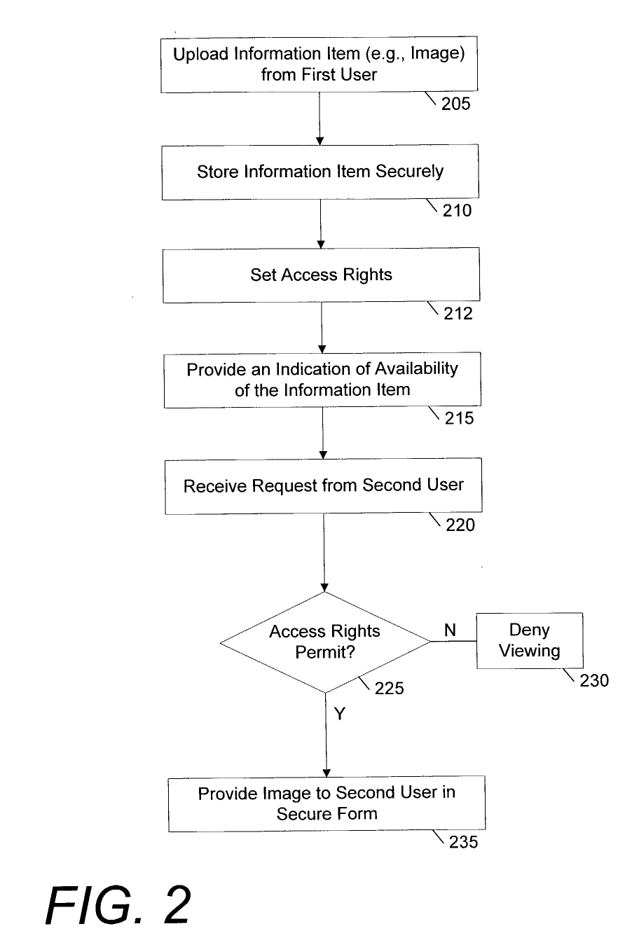

According to one embodiment, the process shown in FIG. 2 may be used to share the particular information element. As indicated in block 205, the information item is uploaded onto the server 130. The information item may be uploaded via a web site interface provided to the server 130 or by other techniques (file transfer protocol, etc.). The server uploads the image into a database 150 from the user, storing the information item securely as indicated in block 210. In one embodiment, the incoming information item may be encrypted by the encryption module 140 and then stored in the database 150 as an encrypted image 151. A randomly selected (or otherwise generated) seed or key may be used for each image and stored in the database in a manner that associates the seed with the image.

The encryption technique used by the encryption module 140 may be any of a variety of known or otherwise available two-way encryption techniques (e.g., well known DES, MD5, Blowfish, etc.), or a derivative of a such a techniques to complicate unauthorized decryption attempts. A two way encryption technique allows the image to be encrypted when received (and stored in an encrypted format) and then decrypted in order to re-construct the original image on the client (recipient user) machine. Furthermore, it may be desirable to utilize an encryption scheme that utilizes seeds or keys to encrypt the image. The seed or key may also be stored in the database 150 with the encrypted image. Without the seed or the key, the encrypted data is typically not decipherable. Thus, the image data cannot be viewed unless all three components (the viewer routine, the encrypted image data, and the seed) are obtained, identified, and used properly.

In various embodiments, the user may set access right attributes in an access rights entry 152 in the database 150 to limit or restrict recipient access rights as indicated in block 212. The access rights may allow limited or restricted access and therefore track more than just a binary indication of whether or not access or a certain type of access (e.g., read, write, etc.) is presently permitted. Rather, in some embodiments, the access rights indicate a depleting access attribute. For example, the access attribute may be a number of views that is reduced when the recipient views the image, or may be a limited duration which is reduced as time passes. In another embodiment, the access attribute may be a cost which a recipient of the image can pay to view the image. The collection module 136 may collect such fees, verify such fees are paid, and/or verify accounts, in some cases by testing whether subscription fees are paid.

Once the access rights are set, the user may provide an indication of availability of the information item to the intended recipient as indicated in block 215. To provide an indication of availability of the information item, a variety of steps may be taken. For example, in some embodiments an email message, instant message, or other type of messaging may be used to actively provide (i.e., push) a notification or indication of availability to the user. Thus, the notification module 134 of the server 130 may be a module that actively sends such a message or a module that displays the indication. For example, the server 130 may run a program that allows the user to cause the server to dispatch notifications (e.g., email messages) to designated recipients.

In other embodiments, the indication of availability may be a link that is viewed on a web page, an icon, a thumbnail view, or any other image, button, or other indicator that conveys to a user that the information item may be available to view. For example, the recipient may have an account with the web site that stores the information, and when the recipient logs in to that web site, a screen may be provided notifying the user of any current invitations. In either case, the notification module 134 provides some indication or notification to the recipient that an information item is available for viewing. In other embodiments, the user may utilize his or her own email or other messaging program to provide notification.

As indicated in block 220, in response to the notification, the intended recipient may respond and indeed request to view the information item of which the recipient was notified. Whether the proper access rights have been granted for the requester to view the information element is determined as indicated in block 225. In the embodiment of FIG. 1, the request is received by the server 130 and the access rights module of FIG. 1 checks the access rights entry 152 for Recipient 1 associated with User 1's encrypted image 151. If the access rights entry 152 indicates that access should not be granted, then viewing is denied, as indicated in block 230. If the access rights entry 152 indicates that access should be granted, then the information item may be provided to the user in a secure form as indicated in block 235. Thus, in the embodiment of FIG. 1, if the access rights module 132 approves the request, the transmission module 138 may be activated to provide the information item to the user.

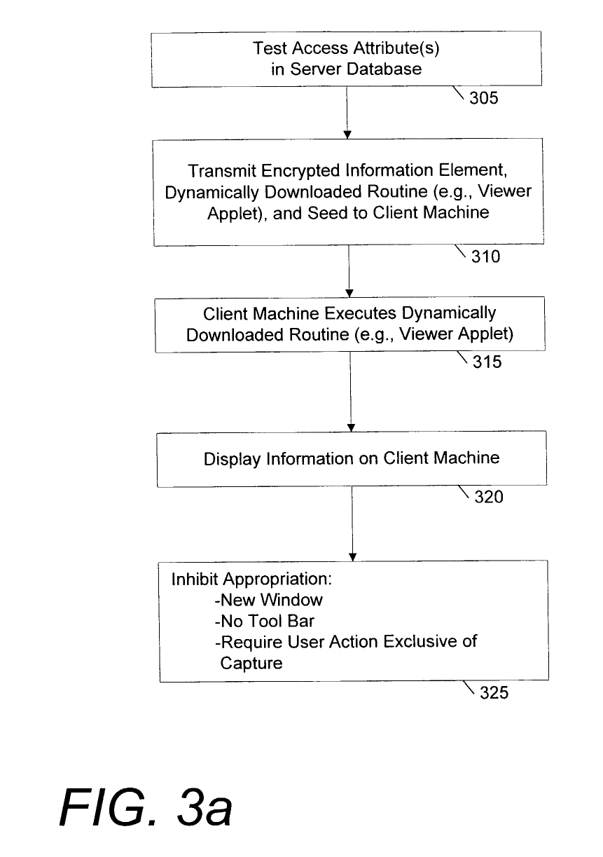

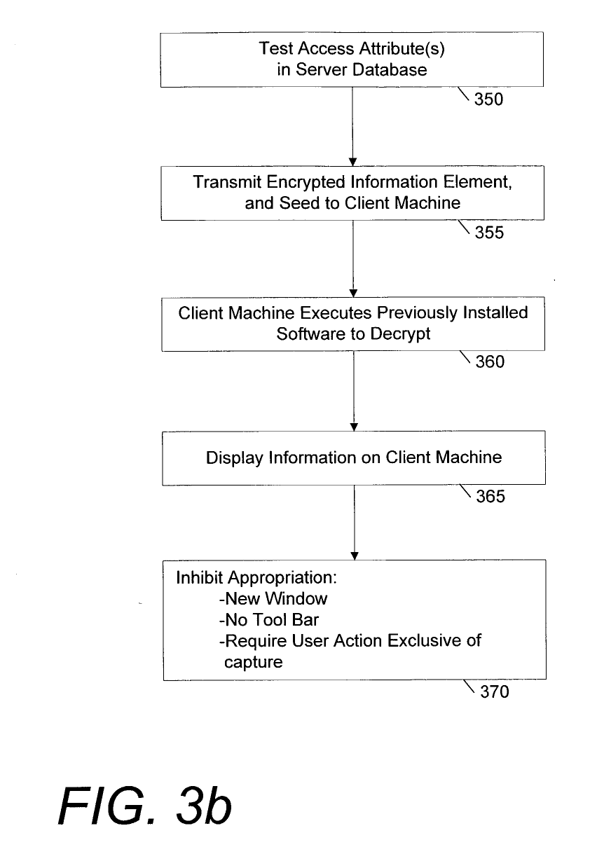

The transmission module 138 may provide the information item to the user in a variety of manners. For example, the transmission module and/or access routine may operate according to portions of FIG. 3a or FIG. 3b. In the embodiment of FIG. 3a, the access attributes in the server database 150 have been tested (and access approved) as indicated in block 305. After such approval, three items are transmitted to the client (recipient) machine as per block 310. The three items are the information element in encrypted form, a dynamically downloaded routine, and a seed. The client machine executes the dynamically downloaded routine (a viewer routine) as indicated in block 315, thereby decrypting and displaying the information on the client machine as indicated in block 320.

The viewer routine may be dynamically distributed over the Internet with little or no interaction required by the user (no installation, etc., required). In some embodiments, the viewer routine may be a web-served application or applet. Thus, the viewer routine may remain a dynamically loaded routine associated with the server or the network site or link rather than being installed or a component of a browser or other program. Thus, little or no extra user intervention (beyond requesting access to the information element) may be required in order to display the information element, assuming the proper access restrictions are met.

For example, in one embodiment, the recipient clicks on a link to the desired information element (e.g., image). While the link may appear to merely link to the image because the image is rendered in response to clicking on the link, in fact the link is a link to the viewer routine. The viewer routine is loaded in response to actuation of the link and executes to provide the expected display. In one embodiment, the viewer routine itself downloads the encrypted information item and the seed if a seed is also used. In either case, the viewer routine accesses the encrypted information item, whether locally or remotely stored.

Such an approach may provide a reasonable degree of security to users. The image is not transmitted to the user machine except in encrypted form. Additionally, the particular decryption code is only served to the client machine for dynamic execution and is not available for running as a standard program on the client machine. Finally, the seed is required to decrypt the encrypted image. Of course, any or all of these items may be at least temporarily cached on the client machine, but identifying, isolating, and properly combining all three may be sufficiently difficult to greatly reduce the likelihood of misappropriation of the displayed information.

Furthermore, the image may be rendered in a manner that inhibits reproduction, as indicated in block 325. First, the image may be rendered in a new window which does not have a tool bar or a menu such that the image can not be easily saved, printed, or the like. Additionally, the viewer routine may render the image such that the usual right clicking on the image available under some operating systems is unable to allow the user to save the image. The viewer routine may also cause the image to flash or distort (e.g., become wavy) over time, so that a viewer can understand the picture, but it is difficult to capture at any single point in time.

To inhibit any type of print-screen or capture command, the applet may require the user to actuate some user input that would prevent or make difficult actuating other inputs that would be required to effect a print-screen or the like. For example, the applet may require the user to hold down the space bar (or some other key or combination of keys) while viewing the image. Alternatively, the applet may require the user to click a mouse button or perform some other user activity which either practically or functionally complicates or precludes capture of the image.

Another alternative for transmitting and displaying the information element is shown in FIG. 3b. In the embodiment of FIG. 3b, the access attributes in the server database 150 have been tested (and access approved) for a recipient as indicated in block 350. After approval, the information element is transmitted in encrypted form along with a seed or a key to decrypt the encrypted data, as indicated in block 355. In this embodiment, the viewer routine is not a dynamically downloaded routine such as an applet that may be downloaded on-demand as needed in response to a request to view the information element. Rather, the viewer routine in this embodiment is installed on at least a semi-permanent basis as a stand-alone program or as a plug-in to an application such as a browser or other information viewing application. In one embodiment, the viewer routine may be a portion of an instant messenger program. Such instant messenger programs typically include a downloaded and installed program or program portion. Using an instant messenger or other installed program may allow various operating system routines to be accessed that may not otherwise be available through dynamically downloaded programs such as applets. Thus, for example, operating system level security features may be used to provide more a robust secure picture sharing solution.

Therefore, as indicated in block 360, the recipient (client) machine executes the previously installed software to access the seed and encrypted data, decrypt the image, and display the image as indicated in block 365. Similarly to the embodiment of FIG. 3a, various techniques may be used to inhibit appropriation of the information once that information is displayed as indicated in block 370.

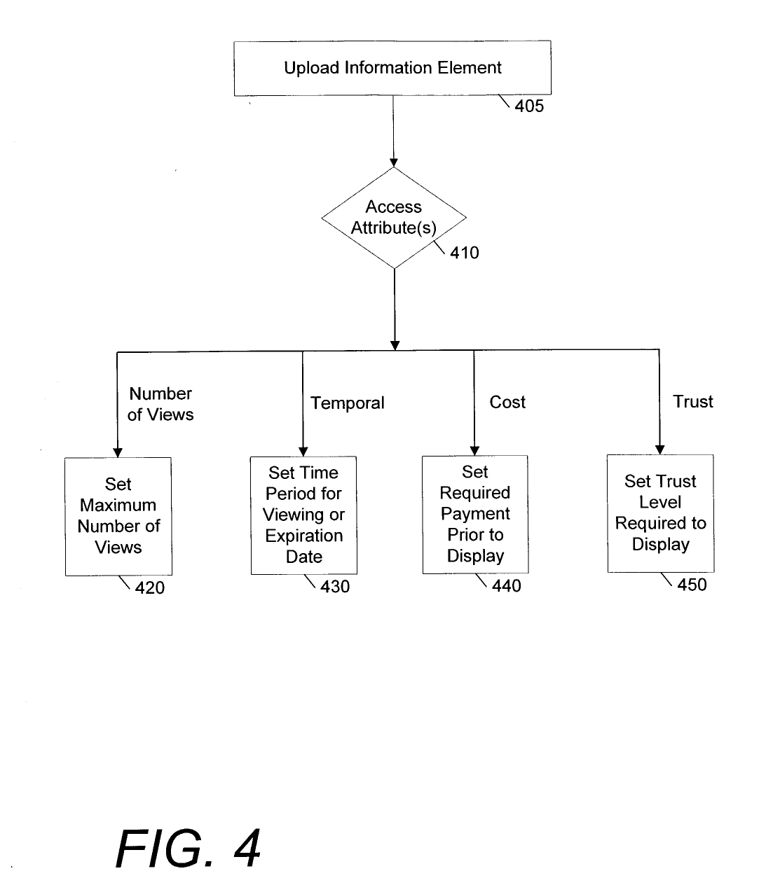

FIG. 4 details various techniques that may be used to provide access control. Some embodiments may allow an information-posting user to choose various different types of access rights or combinations of access rights to grant. Other embodiments may allow a limited set of options or a single option. In this embodiment, an information element is uploaded as indicated in block 405. Depending on which type of access control is desired (decision block 410), the proper access limitations may be put in place. For example, if a limitation on the number of views is desirable, then an access attribute setting a maximum number of views may be set by the information-providing user as shown in block 420. A particular information sharing system may implement only one of these options or may implement some, all, or even more access restrictions.

If a temporal limit is desirable, then a variety of different time limits may be set as indicated in block 430. An information-providing user may decide to allow a recipient to view the information until a certain date (i.e., an expiration date). Alternatively, the recipient may be granted a certain time period from the time of first viewing-to further view the image. Alternatively, a-time window may be set, in which a start and end of a viewing period may be specified. Furthermore, the duration which the viewer routine allows the information element to remain on the display of the recipient may be specified in some cases.

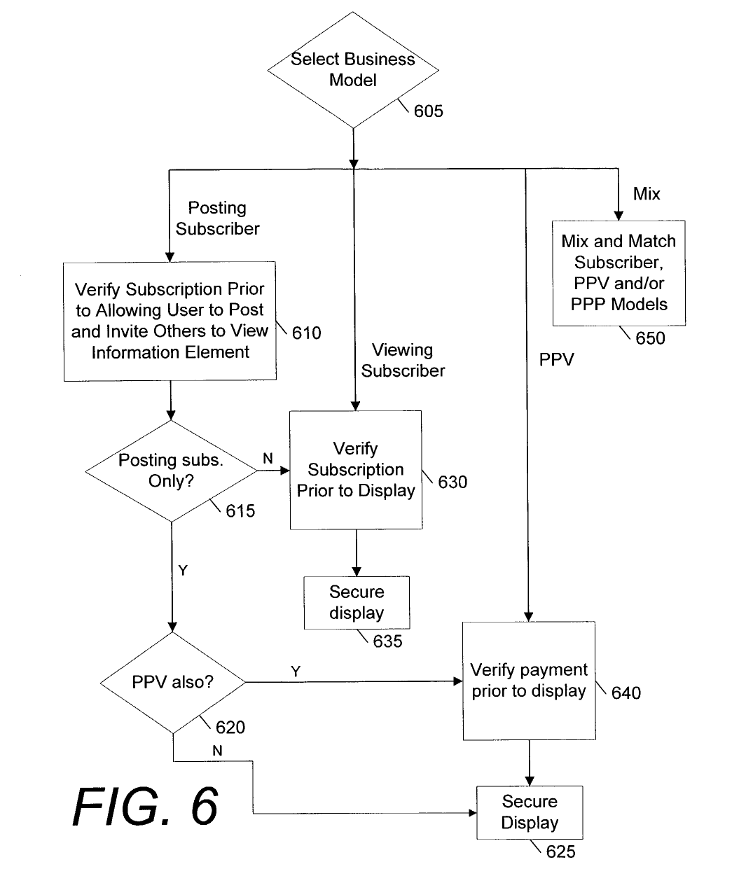

If monetary compensation is expected in order to view the information from the information supplier, then the access attribute may specify the monetary amount required prior to display as indicated in block 440. A simple fixed fee may be charged for each viewing. In one embodiment, the fixed fee is shared between the information-provider and the proprietor of the information sharing system (e.g., the server, modules, etc.). More elaborate escalating fees, variable fees, subscription fees, or other fees may also be charged in order to allow a recipient to view a particular information element. In addition, or alternatively, users of the information sharing system may be required to subscribe to the service in general, as will be further discussed below with respect to FIG. 6.

In some embodiments, a concept of a user trust or privilege level may be established. For example, a user may obtain a high trust rating by being rated favorably by other users. For example, a user can be ranked either in terms of previous interaction experiences or by the number of interactions or both. Alternatively, a user may obtain a high trust rating by being designated by a particular user as a trusted recipient with respect to that user. In any case, a variety of techniques may be used to establish when a user is a trusted user. A trust level may be set to indicate which users are sufficiently trusted to view images as indicated in block 450. The trust level may be a trust ranking that exceeds a selected threshold or just an indication of whether or not the recipient qualifies as trusted.

Additionally, other similar types of time, space or equipment based restrictions may be imposed. Viewing may be prohibited on certain devices or types of devices or only permitted in certain locations or on certain machines. Viewers may also be restricted differently on different types of machines or in different locations. For example, only a low resolution copy of an image may be sent to certain devices where a risk of misappropriation is higher. Implementation of these or other similar restrictions should be apparent to one of skill in the art.

The various access restrictions specified by the information provider may be stored in the database 150 on the server 130 as shown in FIG. 1. Each information-providing user (e.g., User 1 154-1 through User N 154-N) may have a database entry with one or more images and access attributes for each image associated with particular specified users. Thus, when the information provider uploads an image and specifies access rights, those rights may be specified for a particular intended recipient. The means to identify the recipient may be a user identification specific to the information sharing system (e.g., a user identification established with an account). Alternatively, a messaging address, such as an email address, or other identifier, may be used to identify the recipient. In either case, access attributes may be set for a particular identified user. The “real” identity of the user need not necessarily be known for that user to be “identified”. However, some user identification is used in this embodiment so that rights specific to particular users may be granted. In some cases, a group identifier may be used by a number of persons.

In other embodiments, a general access condition may be specified. For example, it may be specified that as long as someone pays a designated amount, they may view the information element. Notably, multiple restrictions may be placed on a particular image with respect to viewing. All the particular restrictions may be stored in the database, whether or not in association with particular recipients.

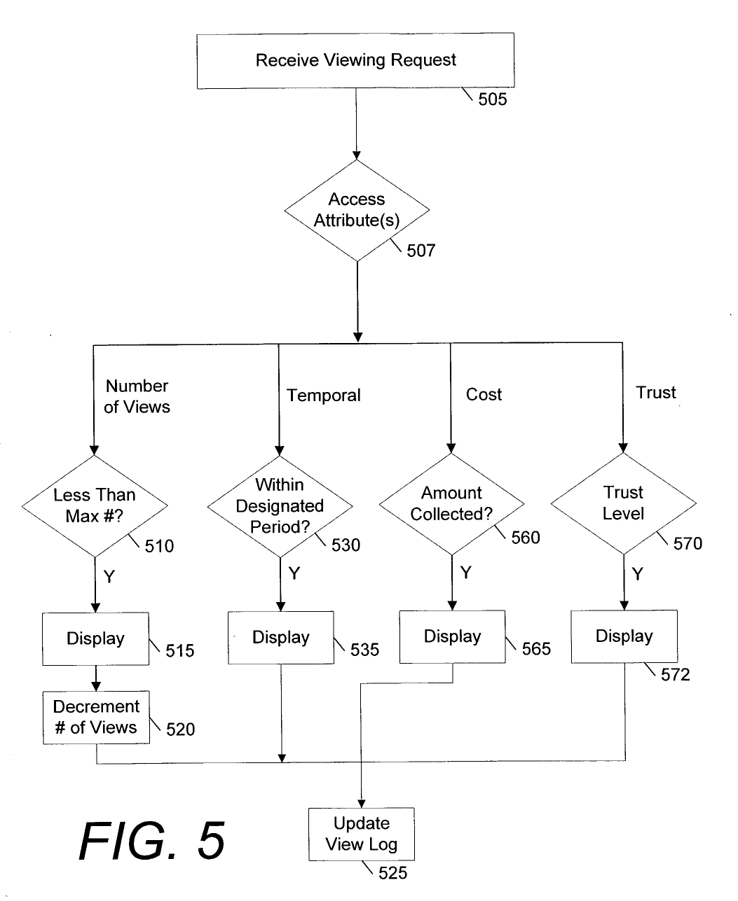

FIG. 5 details operations occurring when a viewing request is received according to one embodiment. After the viewing request is received in block 505, depending on the particular access restrictions implemented via the information system (as determined at block 507), different access right checks may be performed. For example, if the access attribute for the particular recipient making the request has a number-of-views restriction, then whether less than the maximum number of views have been completed is tested in block 510. If the maximum number of views has been reached, then the image is not displayed, and a message may be displayed informing the recipient of the reason the request is denied. Assuming that the recipient has requested fewer than the maximum number of views, the image is displayed, as indicated in block 515, and the access attribute is changed by decrementing the number of remaining views as indicated in block 520.

If a temporal limit is imposed on viewing, then whether or not the request to view the information falls within the designated period is tested in block 530. If not, then the request is refused. If the request does fall within the designated period, then the information is displayed, as indicated in block 535. If an amount is to be collected in order for the recipient to view the information, then whether the amount has been collected is determined in block 560. Various collection means may be used. For example, a recipient may have an established account on the information sharing system with a credit card, banking, or other automated funds transfer mechanism to facilitate payment. Alternatively, the payment verified may be a subscription payment by the recipient to the information sharing system proprietor. Thus, granting of a request from the recipient may require a payment which is either verified, triggered, or triggered and verified in block 560. Moreover, both a subscription and a payment to view the image may be verified. Once the payment has been processed or confirmed, then the image is displayed, as indicated in block 565.

If a trust level is required in order for a recipient to gain access to the information, then whether the recipient has the appropriate trust or privilege characteristic is tested in block 570. If the requester is a trusted requester or has a trust level ranking above a selected threshold, then the image may be displayed as indicated in block 572. As previously mentioned with respect to FIG. 4, a combination of the access attributes may be imposed for a particular information item. Likewise, a complementary combination of access attribute checks may be performed prior to providing access.

The information sharing system may also maintain a view log which may benefit the information-supplying user or be useful to the information system proprietor. Thus, as indicated in block 525, after or when images have been displayed in blocks 515, 535, or 565, various aspects of the access may be tracked. The recipient may be tracked, along with the time, date, etc. Moreover, duration of viewing may be tracked in some cases, along with any other pertinent or useful facts, such as origin of request/location of viewing, etc.

As indicated in FIG. 6, a variety of business models may be established for an information sharing system utilizing presently disclosed techniques. In block 605, a particular business model is selected. In a posting subscriber business model, those who post information subscribe to the service and pay a subscription fee. Thus, as indicated in block 610, the subscription is verified prior to allowing a posting user to invite others to view an information element. Additionally, the posting subscriber model may be combined with a pay-per-view (PPV) model and/or a viewing subscriber model.

If the viewer is required to subscribe to view images, then the viewer subscription is verified prior to display in block 630. This point may be reached in a pure viewing subscriber model from block 605 or in a combination model from block 615. If the viewer subscription is up-to-date, then the information element may be securely displayed as indicated in block 635.

In a pay-per-view model, the user pays to view the information either each time or for a number of times. Payment is verified prior to display, as indicated in block 640. If the payment can be verified, then the image may be securely displayed, as indicated in block 625. Block 640 may be reached either directly in a pure pay-per-view model from block 605 or from block 620 in a combination model. In block 615, if only the information-posting user is required to subscribe, then whether the viewer may be required to pay on a pay-per-view basis is determined in block 620. Finally, if the posting subscriber model is not also a pay-per-view model, as determined in block 620, then the information may be displayed as per block 625 after block 620.

Various other combinations and permutations are possible as will be apparent to one of skill in the art and a mixed model may be used as indicated in block 650. For example, a viewer subscription model could also include some or all information that is viewable on a pay-per-view basis. Alternatively, the business model may not require any payment at all, but rather may be a value-added service provided to make an information sharing service more attractive. For example, disclosed information sharing techniques could be provided for free to improve sites such as the Yahoo! briefcase and Ofoto, which generate revenue via other means such as advertising and photo print sales. Additionally, a single information sharing system may not implement all of the decision blocks and perform all of the testing as indicated, but rather may implement one specific model of the various combinations and permutations described or within the reach of one of skill in the art, given these descriptions.

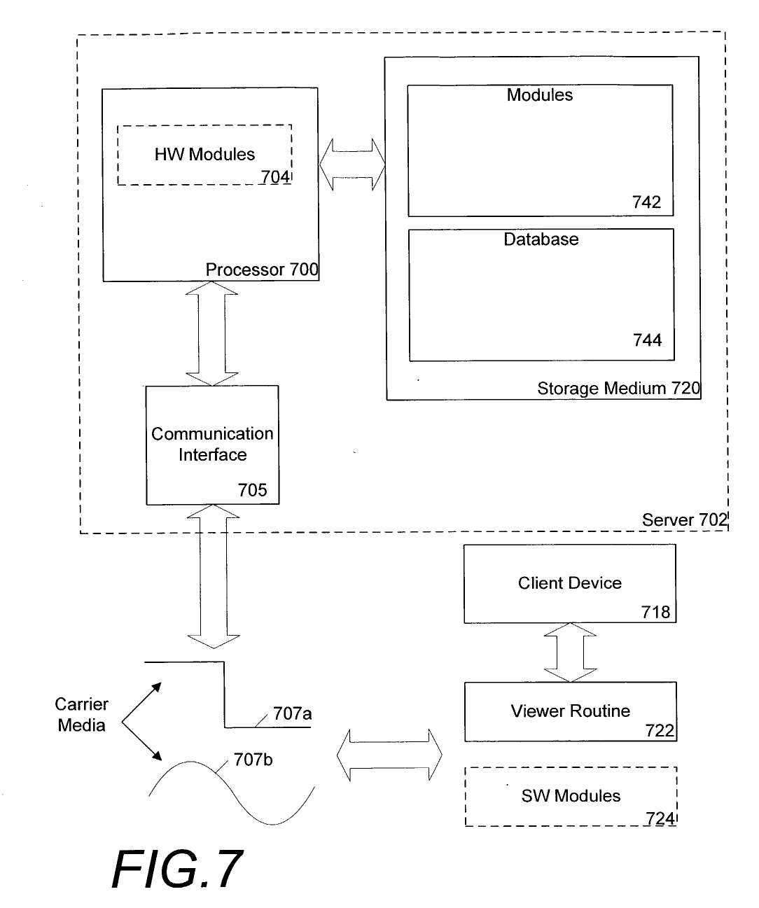

FIG. 7 illustrates an information sharing system and various implementation options that may be used in some embodiments. In the embodiment of FIG. 7, a server 702 may be used to implement the functionality described for the various modules. The server 702 may represent a single server or a set of servers, computing devices, or processors. The modules may be logic, circuitry, microcode, software, a combination of execution logic and software, or any combination of these or other functionality-implementing techniques. Thus, in one embodiment, the required functionality may be built in to a processor 700 in various forms as hardware modules 704. In another embodiment, the modules may be software routines that are stored in a storage medium 720 (such as a memory or a magnetic or optical disk) and executed by the processor 700, as indicated by modules 742 contained in the storage medium 720. In other embodiments, the modules may be implemented in system logic or split between some combination of one or more of the processor, software, and system logic. Additionally, storage medium of the server 702 includes the database 744 which stores images, user identifications, access rights, etc.

The server 702 further includes a communication interface 705. The communication interface 705 may interact with a digital communication medium 707a or an analog communication medium 707b to transfer information over the communication medium. For example, as previously described, an encrypted image and in some cases a seed for that image may be transmitted to a user (e.g., to a client device 718). A viewer routine 722 may be transmitted to the client device 718 to execute on the device, decrypt the image, and display the image, preferably in a relatively secure fashion. Additionally, various software modules 724 could be transmitted to the server 702 via the communication medium.

Whether the modules are hardware or software, they may be represented by data in variety of manners. A hardware design may go through various stages, from creation to simulation to fabrication. Data representing a design may represent the design in a number of manners. First, as is useful in simulations, the hardware may be represented using a hardware description language or another functional description language Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. In a software design, the design typically remains on a machine readable medium, but may also be transmitted as in the case of the carrier media 707a and 707b. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) embodying techniques of the present invention.

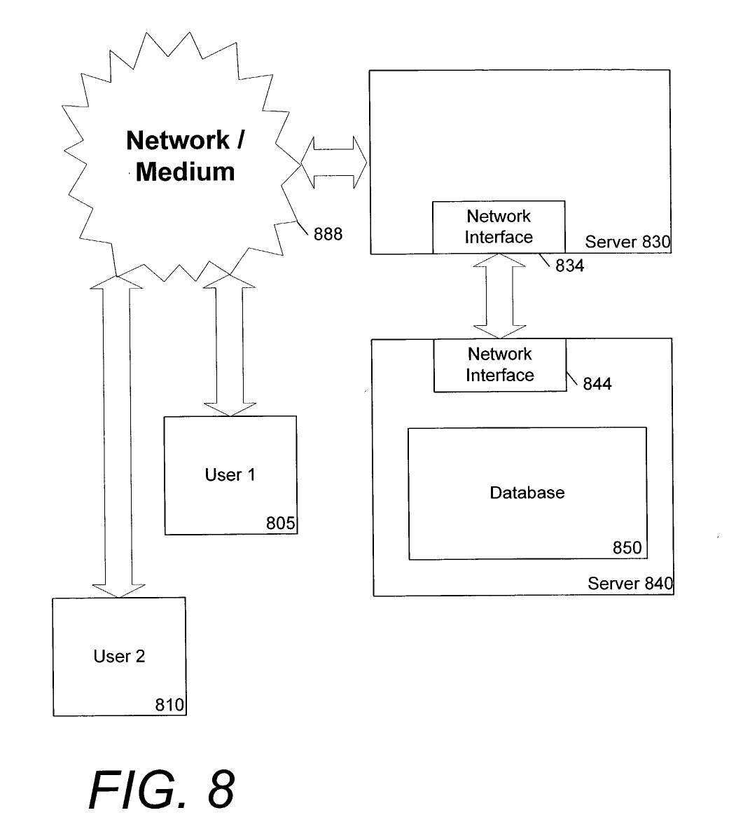

FIG. 8 illustrates one embodiment of an information sharing system that provides added security to safeguard information in a database 850. In the embodiment of FIG. 8, a first server 840 that stores the database 850 has a network interface 844 to connect to a second server 830 via its network interface 834. The second server 830 is connected to a network or medium 888 for communication with other machines. The network or medium may be the Internet or may involve a variety of communication links and protocols. The underlying communications facilities are not critical for various disclosed embodiments. The network/medium 888 allows the server 830 to communicate with user computing devices 805 and 810 to allow information sharing of information in the database 850.

In the embodiment of FIG. 8, the database is protected because there is no direct access from the network/medium 888 to the server 840. So, for example, firewall and other protection may be provided by the server 830, and direct access to the database 850 may be prevented. Various other known or otherwise available security and isolation techniques may also be used in conjunction with presently disclosed techniques in order to enhance overall information security.

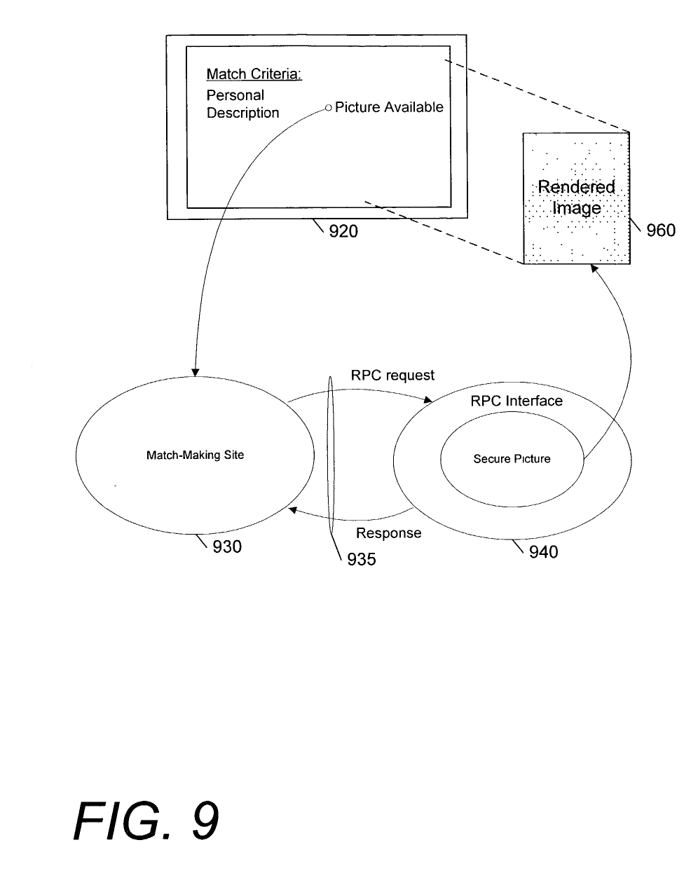

FIG. 9 illustrates one exemplary embodiment wherein disclosed techniques may be employed. In the embodiment of FIG. 9, a secure picture site 940 interacts with a match-making (i.e., dating or courtship) oriented site in order to provide images in conjunction with user information. For example, a user may enter various criteria for a potential new acquaintance. A search is performed and the user may view on a display 920 any matches found. The display may indicate various characteristics (e.g., age, height, hobbies, interests, etc) of an individual. The display may also indicate that a picture is available for this match.

If the user clicks through to view the picture, the match-making site 930 may send a remote procedure call (RPC) to an RPC interface of the secure picture web site 940. In one embodiment, a markup language such as extensible markup language, may be used to provide a remote procedure call interface, but other embodiments may interact via different known or otherwise available interface techniques. The secure picture web site 940 may respond to the match making site 930 to indicate whether the request was successful. The request and response 935 may be performed by a secure communication technique or through a secure socket layer, etc. The request from the match making site 930 may include an authorization to charge the requesting viewer an amount to view the image. In some embodiments, it may be required that the requesting viewer have established an account with the secure picture web site 940 in advance to providing the image to the requesting user. In some embodiments, the requesting viewer may need to contact the candidate to request that access attributes be set to allow viewing of the picture of the candidate. In such case, the requester may need to cleverly woo the candidate and perhaps first invite him or her to view the requester's image and/or personal information to obtain the appropriate permission. In one embodiment, the remote procedure calls of Table 1 are supported.

TABLE 1
Example Remote Procedure Calls

| | |
|---|---|
| getPictures(userID,password) | Authenticates remote connection to |
| | allow particular pictures to be shown |
| | or other actions to be taken. |
| showPicture(PictureID,password) | Causes a particular identified picture |
| | to be displayed. |
| showInvitations(userID, | Allows a user to view any invitations |
| password) | logged in secure picture site through |
| | the interface of another web site. |
| addPicture(userID,password) | Adds a picture to the secure picture |
| | site. |
| removePicture(userID,password, | Removes picture from the secure |
| PictureID) | picture site. |
| grantAccess(pictureID,password, | Grants specified access to a recipient |
| recipientID, permissions) | of a particular picture. |
| getViewLog(userID[, filter]) | Allows a log of image viewing |
| | patterns and/or history to be shown. |

Assuming the image request is granted, then the secure picture web site renders an image 960 of the candidate new acquaintance on the display 920. As previously discussed various techniques may be used to inhibit the reproduction of the rendered image 960. Thus, the potential candidate acquaintance is able to share images without undue concern about their theft, and is perhaps able to make some money, in the case where money is charged to view images. In other cases, the secure picture web site may also collect funds either in subscription form or based on viewing, also as previously described.

In an alternative embodiment, a single web site may provide both match-making and secure picture presentation capabilities. In another alternative embodiment, large scale mass messaging (e.g., via email, instant messaging, etc.) may be undertaken to publicize the availability of certain attractive images for viewing. An open authorization, subject to payment, may then be given for users to securely view the image.

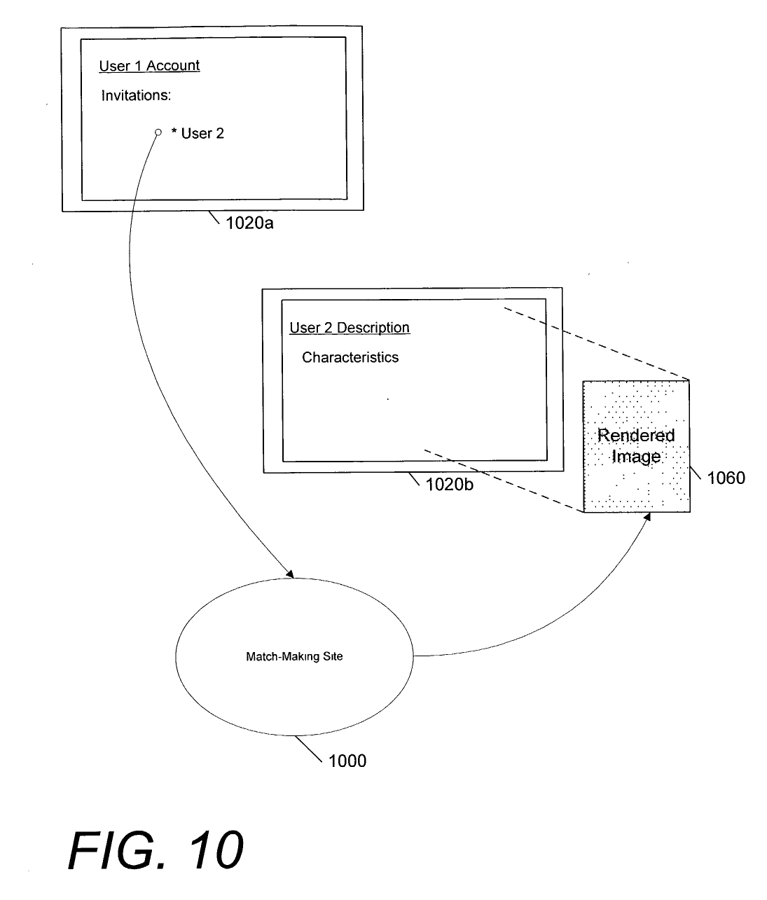

In another alternative embodiment, shown in FIG. 10, a secure picture web site 1000 may provide an invitation based service. The invitation may be in the form of a new invitation that appears when a user logs in to the web site as indicated by User 1's invitation to view User 2's picture in display screen 1020a. Alternatively or in addition, an email notification may be used. If User 1 chooses to accept the invitation from User 1, then User 1 provides an input to the secure picture web site 1000 so indicating (e.g., clicking on a link associated with the invitation). The secure picture web site renders display screen 1020b, giving characteristics of User 2 and rendering the image 1060 of User 2 in a secure manner.

In this embodiment, one user who uploads their image can then specify other users who would be entitled to securely view their image (with limited access rights). Either viewers or posters or both may be required to subscribe to the service. Additionally, each user may be required to have an account. The account may track all open invitations they currently have as well as any invitations they have sent out. Users may have access to view logs for their pictures, or this may be a premium service available at added expense. Users may remain substantially anonymous by having a User ID on the site that is the only identification presented to others who are contacting them or receiving viewing invitations from them. The site database may maintain in secrecy (with respect to other users) any contact information such as an email or other messaging address to allow communication by (the web site) directly providing messages to the invitee without divulging the contact information of the invitee to the inviting user.

Thus, techniques for secure information display and access rights control are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A method comprising:
uploading a first image from a first user;
enabling the first user to set an access attribute that indicates a limited ability for a second user to view the first image;
selectively providing the first image to the second user in a secure form in accordance with the access attribute.

2. The method of claim 1 wherein the access attribute comprises a depleting access control attribute.

3. The method of claim 1 wherein the access attribute comprises one or more of a set consisting of:
a temporal limit, wherein the second user may view the first image at times within the temporal limit;
a number of permitted viewings, wherein the second user is limited to viewing the first image a number of times indicated by the access attribute;
a payment requirement;
a trust level.

4. The method of claim 1 wherein selectively providing the first image to the second user in accordance with the access attribute comprises:
determining if the access attribute permits viewing of the first image;
if the access attribute permits viewing of the first image, then transmitting an encrypted version of said first image.

5. The method of claim 4 further comprising:
if the access attribute permits viewing of the first image, then transmitting a routine to download and decode said encrypted version.

6. The method of claim 5 wherein the routine comprises a dynamically downloadable and executable viewer routine that executes in response to actuation by the second user of a link indicating the first image.

7. The method of claim 1 further comprising:
sending an invitation message to the second user to view the first image.

8. The method of claim 2 further comprising:
verifying a payment status of the second user prior to allowing the second user to access the first image.

9. The method of claim 2 further comprising:
charging the first user to post the first image.

10. The method of claim 1 further comprising:
receiving an identifier indicative of the second user from the first user;
associating the access attribute with the identifier and the first image;
associating other access attributes with other identifiers of other users with respect to the first image.

11. An article comprising a machine readable medium that indicates instructions that, if executed by a machine, cause the machine to perform operations comprising:
uploading a picture from a first user;
enabling the first user to identify a second user and to set an access restriction limiting the second user's ability to view the picture;
providing an indication to said second user that the first user invites the second user to view the picture;
receiving a request from the second user to view the picture;
verifying an account status of the second user to prior to allowing the second user to view the picture;
checking the access restriction prior to allowing the second user to view the picture;
allowing the second user to view the picture dependent on verifying the account status and checking the access restriction.

12. The article of claim 11 wherein allowing the second user to view the picture further comprises:
transmitting a routine to decrypt an encrypted version of the picture to the second user;
transmitting the encrypted version of the picture to the second user.

13. An apparatus comprising:
an access control module to allow a first user to set an access control attribute for a first information item to track a restricted ability of a second user to view said first information item and to test the access control attribute in response to a request from the second user;
a transmission module to transmit said first information item to said second user if said access control module indicates said second user is authorized to view said first information item in response to the request from the second user;
a notification module to indicate to said second user that said first information item is available for viewing responsive to a first user request to notify said second user.

14. The apparatus of claim 13 wherein said access control module is further to allow the first user to specify an identifier of said second user and to associate said access control attribute with said identifier, and further wherein said access control module is to associate a plurality of access control attributes with a plurality of users to control access to said first information item.

15. The apparatus of claim 13 further comprising:
a collection module to verify that said second user has been charged prior to transmitting said first information item to said second user.

16. The apparatus of claim 14 further comprising:
a communication interface;
an encryption module to receive the first information item from the first user via the communication interface and to encrypt the first information item into a first encrypted image, and further wherein said transmission module is to transmit said first information item to the second user by transmitting the first encrypted image.

17. The apparatus of claim 16 wherein, in response to the request from the second user, said transmission module is to transmit a viewer routine to download and decrypt the first encrypted image and to display said first information item.

18. The apparatus of claim 17 wherein the viewer routine is to inhibit printing and/or copying of said first information item.

19. The apparatus of claim 13 wherein said access control attribute tracks one or more of a number of views, and a temporal limit, a trust level, and a payment.

20. An apparatus comprising:
a storage medium to store a plurality of routines, said plurality of routines comprising:
an encryption routine to receive an information item from a first user and to encrypt the information item into an encrypted information item;
an access rights routine to receive a request from a second user to view the information item and to grant or deny the request from the second user based on an access attribute controllable by the first user;
a transmission routine to transmit a viewer routine if the request from the second user is granted, the viewer routine to access, decrypt, and display the encrypted information item upon execution;
a processing element to execute said plurality of routines.

21. The apparatus of claim 20 further comprising:
a communication interface, wherein said information item and said request from said second user are received via the communication interface, and wherein said encrypted information item and said viewer routine are transmitted to the second user via the communication interface if the request from the second user is granted.

22. The apparatus of claim 20 wherein said viewer routine is to inhibit reproduction of said information item.

23. The apparatus of claim 20 wherein said viewer routine is an applet dynamically downloadable and executable by a browser, wherein said information item is to be displayed by said viewer routine in a new window.

24. The apparatus of claim 20 wherein the encryption routine is to store the encrypted information item and a seed, and wherein the transmission routine is to transmit the a decryption routine in response to the request from the second user to view the information item, said decryption routine, when executed, to access the encrypted information item and the seed and to decrypt the encrypted information item and display the information item.

25. The apparatus of claim 24 wherein said access attribute is one or more of a set consisting of:
a time limit;
a number of views;
a cost;
a privilege or trust level.

26. A method comprising:
uploading an information element from a first user;
enabling the first user to control an access attribute that provides a limited ability for a second user to view the information element;
providing an indication of availability of the information element;
testing the access attribute for said information element in response to a request from the second user;
if the access attribute for said information element is in a first state, then transmitting, in response to the request from the second user, a routine to access an encrypted version of said information element and to decode said encrypted version.

27. The method of claim 26 wherein said access attribute comprises one of a time limitation, a number of views limitation, a trust level, or a payment requirement limitation.

28. An article comprising a machine readable medium indicative of a plurality of instructions which, if executed by a machine, cause the machine to perform a plurality of operations comprising:
accessing an encrypted version of an image for which an access attribute indicates viewing is permitted by a second user, the image being previously uploaded by a first user to a mutually accessible storage location, the access attribute being set by the first user to provide a limited ability for the second user to view the image;
decrypting the image from the encrypted version of the image;
displaying the image.

29. The article of claim 28 wherein said plurality of instructions form a dynamically downloaded viewer routine, and wherein said plurality of operations further comprises:
downloading a decryption seed associated with said encrypted version of the image.

30. The article of claim 29 wherein said plurality of operations further comprises:
inhibiting local reproduction of the image.

31. The article of claim 28 wherein said plurality of instructions are a portion of an instant messaging program.

32. The article of claim 31 wherein said plurality of operations further comprises:
utilizing operating system level security features to securely display the image.
